(19) United States
(12) Patent Application Publication
(10) Pub. No.: US 2025/0118335 A1
(43) Pub. Date: Apr. 10, 2025

(54) Systems and Methods for an Empathy Cultivator

(71) Applicant: Wells Fargo Bank, N.A., San Francisco, CA (US)

(72) Inventors: Tali Bray, San Francisco, CA (US); Tiffany Tavarez, Philadelphia, PA (US); Dennis E. Montenegro, Concord, CA (US); Sadie S. Salim, Mill Valley, CA (US)

(21) Appl. No.: 18/127,798

(22) Filed: Mar. 29, 2023

(51) Int. Cl. G11B 27/02; G06V 20/40

(52) U.S. Cl. CPC G11B 27/02; G06V 20/40

(57) ABSTRACT

Systems and methods for an empathy cultivator are disclosed. One disclosed method includes receiving a video signal associated with an experience; applying an enhancement to the video signal to create an enhanced video; and transmitting a signal associated with the enhanced video, wherein the enhancement comprises an addition provided by a sharer of the experience to convey an emotion of the sharer about the experience.

### FIELD OF TECHNOLOGY

The present disclosure generally relates to systems to help organizations develop empathy in their employees through sharing experiences.

### BACKGROUND

Current video-based training systems offer the ability to record a video and include voiceover or other commentary. However, this form of video-based training is insufficient to enable employees to share their feelings about an event with recipients of the training or build empathy. Accordingly, there is a need for systems and methods for an empathy cultivator.

### SUMMARY

According to certain embodiments, a method for an empathy cultivator comprises: receiving a video signal associated with an experience; applying an enhancement to the video signal to create an enhanced video; and transmitting a signal associated with the enhanced video, wherein the enhancement comprises an addition provided by a sharer of the experience to convey an emotion of the sharer about the experience.

According to another embodiment, a system for an empathy cultivator comprises: a processor configured to: receive a video signal associated with an experience; apply an enhancement to the video signal to create an enhanced video; and transmit a signal associated with the enhanced video, wherein the enhancement comprises an addition provided by a sharer of the experience to convey an emotion of the sharer about the experience.

According to another embodiment, a non-transitory computer readable medium may comprise program code, which when executed by one or more processors, causes the one or more processors to: receive a video signal associated with an experience; apply an enhancement to the video signal to create an enhanced video; and transmit a signal associated with the enhanced video, wherein the enhancement comprises an addition provided by a sharer of the experience to convey an emotion of the sharer about the experience.

### BRIEF DESCRIPTION OF THE DRAWINGS

A full and enabling disclosure is set forth more particularly in the remainder of the specification. The specification references the following appended figures.

FIG. 1 shows an example system for an empathy cultivator according to one embodiment of the present disclosure.

FIG. 2 shows another example system for an empathy cultivator according to another embodiment of the present disclosure.

FIG. 3 illustrates a flow chart for a method for an empathy cultivator according to another embodiment of the present disclosure.

FIG. 4 shows an example embodiment of an empathy cultivator according to one embodiment of the present disclosure.

### DETAILED DESCRIPTION

Reference will now be made in detail to various and alternative illustrative examples and to the accompanying drawings. Each example is provided by way of explanation, and not as a limitation. It will be apparent to those skilled in the art that modifications and variations can be made. For instance, features illustrated or described as part of one example may be used in another example to yield a still further example. Thus, it is intended that this disclosure include modifications and variations as come within the scope of the appended claims and their equivalents.

### Illustrative Embodiment of an Empathy Cultivator

The present disclosure uses extended reality technology to cultivate empathy—the ability to understand and share the feelings of another—recognizing that empathy is a foundation of effective collaboration and interactions across increasingly diverse workplaces and marketplaces.

The present disclosure addresses various disconnects that can occur in communication between two people: a sharer (who has an experience) and a recipient (who hears about or watches the experience) in a situation in which the recipient does not understand the experience and perspective of the sharer. For example, in some embodiments, a sharer may comprise one or more of a person who is Black/African American; Hispanic & Latino; Asian; is of Native Peoples decent; Middle Eastern; a Woman; has Disability; is a Veteran; or is LGBTQ+. Such a person may have a different perspective and feelings about events, images, statements, or actions than the recipient. The present disclosure may enable such a sharer to better express their perspective of these events, images, statements, or actions to a recipient and thereby help the recipient to develop empathy for the feelings of the sharer.

In some embodiments, the present disclosure involves an editor to modify a video, which was either previously captured and saved or is being captured (e.g., with a digital camera on a mobile device). The present disclosure allows the sharer to include enhancements to the video to provide the sharer's perspective to the recipient. In some embodiments these enhancements may enable the sharer to convey their feelings about an experience to the recipient.

In some embodiments, the editor includes the ability to add enhancements such as, e.g., visual, audio, or physical cues at various locations within the video. These enhancements may be applied in connection with specific events, images, statements, or actions occurring in the video.

Once created, the video can be shared with others to demonstrate via the enhancements how the video creator “felt” in connection with the action on the video. For example, visual for fear may be an enhancement in the form of shaking (either in the video or by activating a vibration in the device), and anger may be communicated via an enhancement in which the image turns red. These enhancements enable the creator to demonstrate how the creator felt during a particular interaction and the viewer of the video to gain a greater understanding or appreciation of the creator's feelings about the interaction. In some embodiments, the video may be viewed on a smartphone, an AR/VR headset, or in a display for a computing device (e.g., a monitor or projection display).

In some embodiments, the present disclosure enables the sharer to create a foundation for an experience which, in some embodiments, enables the sharer to create a live action film which is the story from the perspective of the sharer as the sharer interacts with their environment. In such an embodiment the sharer specifies points in the video at which enhancements (e.g., modifications to the video such as changes in perspective, audio additions, popups, or changes in contrast/color) will be added.

In some embodiments, the story may be a pre-recorded video. In other embodiments, the story may be a video captured in real time (e.g., on a camera of a mobile device such as a smartphone or tablet). In some embodiments, the present disclosure may use artificial intelligence (“AI”) based visual, audio, or geolocation cues to identify locations in the video to which enhancements should be added. For example, in such an embodiments AI may detect words, phrases or images, and apply a flag to the video to enable the sharer to apply an enhancement associated with the word, phrase, or image.

### Example Systems for an Empathy Cultivator

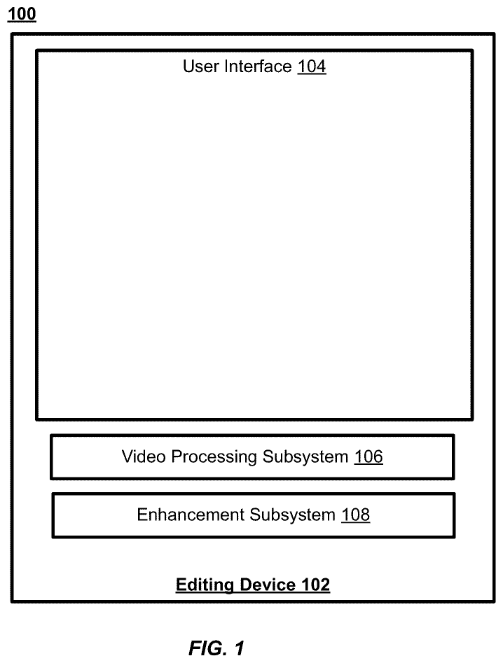

Referring now to the drawings, FIG. 1 depicts an example of a computing environment 100 for providing an empathy cultivator tool, according to certain embodiments disclosed herein. As shown in FIG. 1, the computing environment 100 includes an editing device 102 that includes a user interface 104, a video processing subsystem 106, and an enhancement subsystem 108.

As shown in FIG. 1, the editing device 102 may comprise any kind of known user computing device, e.g., laptop or desktop computer, mobile device (e.g., smartphone or tablet) or other network connected computing device. In some embodiment, the editing device comprises an internal camera (e.g., a digital camera) capable of capturing video. Further, in some embodiments, the editing device 102 includes data storage for storing previously captured videos. In still other embodiments, editing device 102 may access a remote data store of previously captured videos via a network access point (e.g., a wired or wireless network connection).

The editing device 102 includes a user interface 104 to enable a user to interact with software on the editing device 102. The user interface 104 may be a mouse, keyboard, touch screen interface, a voice-based interface, or any combination thereof, or other interface that allows users to provide input and receive output from one or more applications on the editing device 102.

The editing device 102 further includes a video processing subsystem 106. In some embodiments, the video processing subsystem 106 may monitor audio and/or video streams associated to identify audible or visual cues associated with events. For example, the video processing subsystem 106 may detect words, phrases, or images within the video and/or audio stream and apply a flag to the video to enable the sharer to apply an enhancement associated with the word, phrase, or image.

In some embodiments, the video processing subsystem 106 further includes capability for natural language processing. For example, the video processing subsystem 106 may process an audio stream and convert that audio stream into a machine-readable context in order to identify predetermined words, phrases, or actions occurring within the audio stream.

The editing device 102 further comprises an enhancement subsystem 108. The enhancement subsystem 108 comprises a system to apply enhancements to various points throughout a video stream. For example, in some embodiments a sharer may specify one or more points in the video at which enhancements will be applied. These enhancements may comprise one or more of distortions such as changes in perspective (e.g., modifications to the size of people or things within the video), audio additions (e.g., additions of sounds such as audible noises or voiceovers), popups (e.g., textboxes to provide additional description), changes to the contrast or color of the video stream (e.g., addition of a red overlay, changing the video to black and white). These enhancements may enable a sharer to provide a more realistic and immersive feel of their experience with the recipient and thus enable the recipient to develop empathy for the experiences of the sharer.

In some embodiments, the enhancement subsystem 108 may display an interface on user interface 104. For example, in some embodiments, the user interface may comprise an editor including interfaces such as, e.g., buttons, knobs, and sliders, to enable a sharer to apply a particular enhancement and modify the type of enhancement. For example, in one embodiment, a sharer may apply an enhancement that applies a red background when an event occurs that makes the sharer angry. The sharer may then adjust the color of the background with a slider as the event progresses. In such an embodiment, the sharer may further add a text box to explain how the event made the sharer feel.

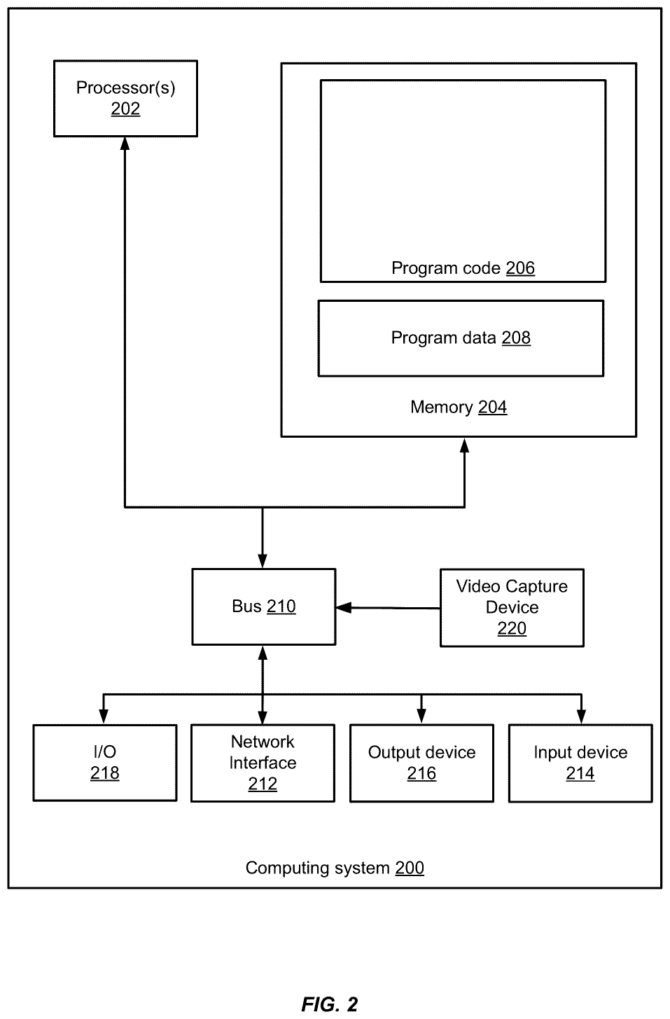

Turning now to FIG. 2, which depicts an example of a computer system 200 for implementing a taxonomy information lookup tool. The depicted example of the computer system 200 includes a processor 202 communicatively coupled to one or more memory devices 204. The processor 202 executes computer-executable program code stored in a memory device 204, accesses information stored in the memory device 204, or both. Examples of the processor 202 include a microprocessor, an application-specific integrated circuit (“ASIC”), a field-programmable gate array (“FPGA”), or any other suitable processing device. The processor 202 can include any number of processing devices, including a single processing device.

The memory device 204 includes any suitable non-transitory computer-readable medium for storing program code 206, program data 208, or both. A computer-readable medium can include any electronic, optical, magnetic, or other storage device capable of providing a processor with computer-readable instructions or other program code. Non-limiting examples of a computer-readable medium include a magnetic disk, a memory chip, a ROM, a RAM, an ASIC, optical storage, magnetic tape or other magnetic storage, or any other medium from which a processing device can read instructions. The instructions may include processor-specific instructions generated by a compiler or an interpreter from code written in any suitable computer-programming language, including, for example, C, C++, C#, Visual Basic, Java, Python, Perl, JavaScript, and ActionScript. In various examples, the memory device 1104 can be volatile memory, non-volatile memory, or a combination thereof.

The computer system 200 executes program code 206 that configures the processor 202 to perform one or more of the operations described herein. The program code 206 may be resident in the memory device 204 or any suitable computer-readable medium and may be executed by the processor 202 or any other suitable processor.

The processor 202 is an integrated circuit device that can execute the program code 206. The program code 206 can be for executing an operating system, an application system or subsystem, or both. When executed by the processor 202, the instructions cause the processor 202 to perform operations of the program code 206. When being executed by the processor 202, the instructions are stored in a system memory, possibly along with data being operated on by the instructions. The system memory can be a volatile memory storage type, such as a Random Access Memory (RAM) type. The system memory is sometimes referred to as Dynamic RAM (DRAM) though need not be implemented using a DRAM-based technology. Additionally, the system memory can be implemented using non-volatile memory types, such as flash memory.

In some embodiments, one or more memory devices 204 store the program data 208 that includes one or more datasets described herein. In some embodiments, one or more of data sets are stored in the same memory device (e.g., one of the memory devices 204). In additional or alternative embodiments, one or more of the programs, data sets, models, and functions described herein are stored in different memory devices 204 accessible via a data network. One or more buses 210 are also included in the computer system 200. The buses 210 communicatively couple one or more components of a respective one of the computer system 200.

In some embodiments, the computer system 200 also includes a network interface device 212. The network interface device 212 includes any device or group of devices suitable for establishing a wired or wireless data connection to one or more data networks. Non-limiting examples of the network interface device 212 include an Ethernet network adapter, a modem, Wi-Fi adapter, Bluetooth adapter, NFC receiver and transmitter, or any other known wired or wireless data transmission system. The computer system 200 is able to communicate with one or more other computing devices via a data network using the network interface device 212.

The computer system 200 may also include a number of external or internal devices, an input device 214, a presentation device 216, or other input or output devices. For example, the computer system 200 is shown with one or more input/output (“I/O”) interfaces 218. An I/O interface 218 can receive input from input devices or provide output to output devices. An input device 214 can include any device or group of devices suitable for receiving visual, auditory, or other suitable input that controls or affects the operations of the processor 202. Non-limiting examples of the input device 214 include a touchscreen, a mouse, a keyboard, a microphone, a separate mobile computing device, etc. A presentation device 216 can include any device or group of devices suitable for providing visual, auditory, or other suitable sensory output. Non-limiting examples of the presentation device 216 include a touchscreen, a monitor, a speaker, a separate mobile computing device, etc.

As shown in FIG. 2, the computing system 200 further includes a video capture device 220. The video capture device 220 may comprise an internal or external camera or array of cameras capable of capturing digital images that form a video. The video capture device 220 may further comprise an audio recording device capable of recording audio associated with the event.

### Example Methods for an Empathy Cultivator

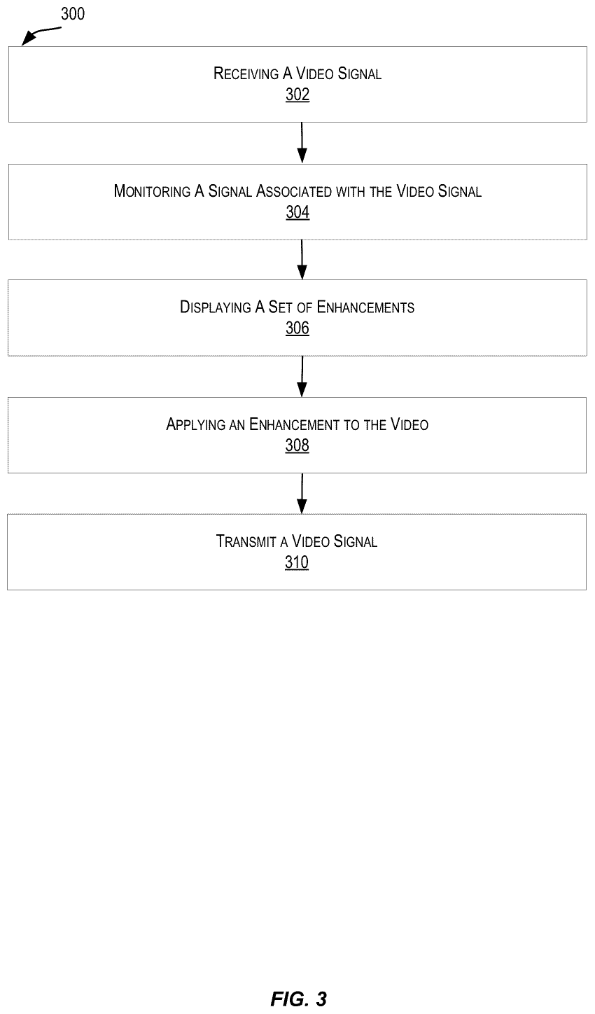

FIG. 3 is a flowchart showing an illustrative method 300 for an Empathy Cultivator according to one embodiment of the present disclosure. In some embodiments, some of the steps in flow charts of FIG. 3 are implemented in program code executed by a processor, for example, the processor in a general-purpose computer, mobile device, or server. In some examples, these steps are implemented by a group of processors. In some examples the steps shown in FIG. 3 are performed in a different order or one or more steps may be skipped. Alternatively, in some examples, additional steps not shown in FIG. 3 may be performed.

As shown in FIG. 3, the method 300 begins at step 302 when processor 202 receives a video signal. In some embodiments, the processor 202 may receive the video signal from video capture device 202. In other embodiments, the processor 202 may receive a signal associated with a prerecorded video stored on a local data store or a data store communicatively coupled to computing system 200, e.g., a cloud-based storage device. In some embodiments, the video signal may further comprise an associated audio stream.

Next at step 304 the processor 202 monitors a signal associated with the video signal. In some embodiments, the processor 202 executes an artificial intelligence (AI) or machine learning application to modify the video and or audio signal to identify triggers within the audio or video signal. These triggers may comprise, for example, particular words or phrases, tones of voice, shouting, objects displayed, or actions by people in the video. In some embodiments, the processor may tag each of these triggers to enable a user (e.g., the sharer discussed above) to apply an enhancement to the video at the location associated with the identified trigger.

Then at step 306 the processor 202 displays a set of enhancements in user interface 104. In some embodiments, the enhancements may comprise one or more of changes in perspective (e.g., modifications to the size of people or things within the video), audio additions (e.g., additions of sounds such as audible noises or voiceovers), popups (e.g., textboxes to provide additional description), changes to the contrast or color of the video stream (e.g., addition of a red overlay, changing the video to black and white). These enhancements may enable a sharer to provide a more realistic and immersive feel of their experience with the recipient and thus enable the recipient to develop empathy for the experiences of the sharer.

Further, in some embodiments, the user interface may comprise an editor including interfaces such as, e.g., buttons, knobs, and sliders, to enable a sharer to apply a particular enhancement and modify the type of enhancement. For example, in one embodiment, a sharer may apply an enhancement that modifies the perspective of people in the video display, e.g., making the other people in the display much larger to appear as giants. Such an enhancements may be accompanied by additional harsh audio and a text box indicated that the actions of the people in the video make the sharer feel fear.

Next at step 308 the processor 202 applies the enhancement to the video signal. For example, the processor may apply the enhancement by modifying the video signal and/or an audio track associated with the video signal to include the enhancement and thereby create an enhanced video signal. In some embodiments, the enhanced video signal may be stored on a local or remote (e.g., cloud-based) data storage for later viewing.

Then at step 310 the processor 202 transmits a video signal to display the enhanced video. The processor 202 may transmit the enhanced video signal for display on on-board display device, e.g., a touch-screen display device. Alternatively, the processor 202 may transmit the enhanced video signal to a projection device or other display to enable the sharer to share the video with a recipient who views the video. In some embodiments, the recipient may view the video on, e.g., an Augmented Reality or Virtual Reality headset.

In some embodiments, the sharer may comprise one or more of a person who is Black/African American; Hispanic & Latino; Asian; is of Native Peoples decent; Middle Eastern; a Woman; has Disability; is a Veteran; or is LGBTQ+. The enhancements applied by the sharer may enable the sharer to better convey their feelings and perspectives about one or more of events, images, statements, or actions. A recipient may view the enhanced video and develop a better understanding and empathy of the perspective of the sharer.

### Example Embodiments of an Empathy Cultivator

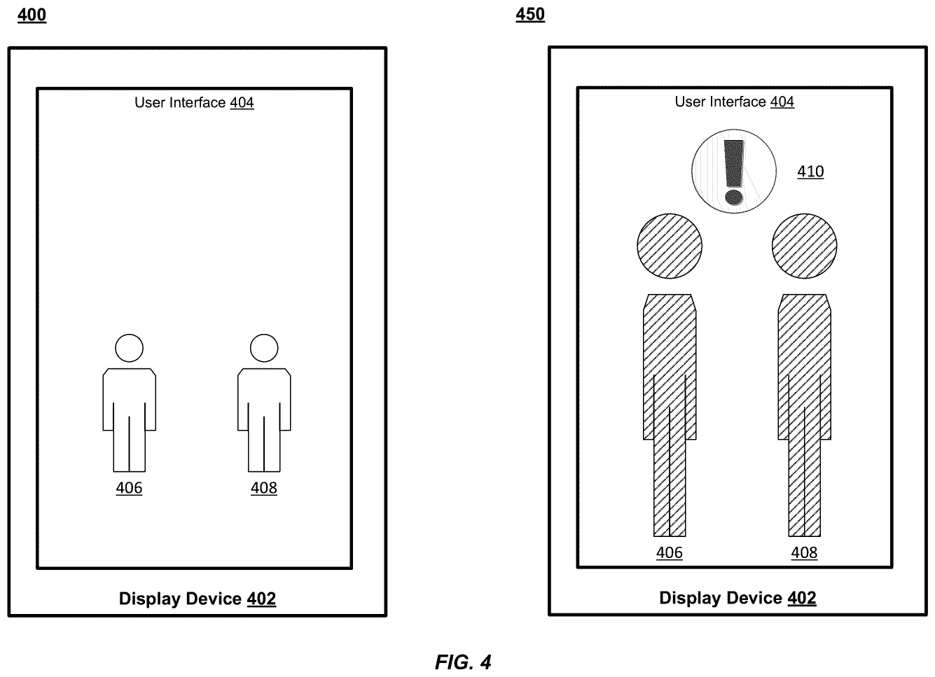

FIG. 4 shows an example embodiment of a taxonomy information lookup according to one embodiment of the present disclosure. As shown in FIG. 4, the system 400 shows an example display device 402 including user interface 404 displaying to people 406 and 408. The system 400 shows a video signal prior to a sharer applying enhancements, as discussed above.

FIG. 4 further includes system 450, which shows display device 402 after application of enhancements by a sharer. As shown in system 450, the sharer has modified the perspective of people 406 and 408 to indicate that they are now much larger, appearing as giants. Such an enhancement may indicate that the sharer is afraid or threatened by actions taken by people 406 and 408. The sharer has further added an exclamation point 410 to provide emphasis to the enhancement.

In other embodiments, the sharer may modify different or additional features of the video signal. These enhancements may convey any feeling of the sharer, e.g., negative feelings such as exclusion, fear, shame, or anger. Alternatively, these enhancements may convey positive feelings, e.g., strength, confidence, or empowerment. For example, some enhancements may apply positive imagery or commentary to the video stream at locations where positive interactions occur. In either instance, these enhancements enable the sharer to better convey their feelings associated with events captured in the video stream.

### General Considerations

Although the subject matter has been described in language specific to structural features or methodological acts, it is to be understood that the subject matter of the appended claims is not necessarily limited to the specific features or acts described above. Rather, the specific features and acts described above are disclosed as examples.

Various operations of examples are provided herein. The order in which one or more or all of the operations are described should not be construed as to imply that these operations are necessarily order dependent. Alternative ordering will be appreciated based on this description. Further, not all operations may necessarily be present in each example provided herein.

As used in this application, “or” is intended to mean an inclusive “or” rather than an exclusive “or.” Further, an inclusive “or” may include any combination thereof (e.g., A, B, or any combination thereof). In addition, “a” and “an” as used in this application are generally construed to mean “one or more” unless specified otherwise or clear from context to be directed to a singular form. Additionally, at least one of A and B and/or the like generally means A or B or both A and B. Further, to the extent that “includes”, “having”, “has,” “with,” or variants thereof are used in either the detailed description or the claims, such terms are intended to be inclusive in a manner similar to the term “comprising”.

Further, unless specified otherwise, “first,” “second,” or the like are not intended to imply a temporal aspect, a spatial aspect, or an ordering. Rather, such terms are merely used as identifiers, names, for features, elements, or items. For example, a first state and a second state generally correspond to state 1 and state 2 or two different or two identical states or the same state. Additionally, “comprising,” “comprises,” “including,” “includes,” or the like generally means comprising or including.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Headings, lists, and numbering included herein are for ease of explanation only and are not meant to be limiting.

Embodiments in accordance with aspects of the present subject matter can be implemented in digital electronic circuitry, in computer hardware, firmware, software, or in combinations of the preceding. In one embodiment, a computer may comprise a processor or processors. The processor comprises or has access to a computer-readable medium, such as a random-access memory (RAM) coupled to the processor. The processor executes computer-executable program instructions stored in memory, such as executing one or more computer programs including a sensor sampling routine, a haptic effect selection routine, and suitable programming to produce signals to generate the selected haptic effects as noted above.

Such processors may comprise a microprocessor, a digital signal processor (DSP), an application-specific integrated circuit (ASIC), field programmable gate arrays (FPGAs), and state machines. Such processors may further comprise programmable electronic devices such as PLCs, programmable interrupt controllers (PICs), programmable logic devices (PLDs), programmable read-only memories (PROMs), electronically programmable read-only memories (EPROMs or EEPROMs), or other similar devices.

Such processors may comprise, or may be in communication with, media, for example tangible computer-readable media, which may store instructions that, when executed by the processor, can cause the processor to perform the steps described herein as carried out, or assisted, by a processor. Embodiments of computer-readable media may comprise, but are not limited to, all electronic, optical, magnetic, or other storage devices capable of providing a processor, such as the processor in a web server, with computer-readable instructions. Other examples of media comprise, but are not limited to, a floppy disk, CD-ROM, magnetic disk, memory chip, ROM, RAM, ASIC, configured processor, all optical media, all magnetic tape or other magnetic media, or any other medium from which a computer processor can read. Also, various other devices may include computer-readable media, such as a router, private or public network, or other transmission device. The processor, and the processing, described may be in one or more structures, and may be dispersed through one or more structures. The processor may comprise code for carrying out one or more of the methods (or parts of methods) described herein.

While the present subject matter has been described in detail with respect to specific embodiments thereof, it will be appreciated that those skilled in the art, upon attaining an understanding of the foregoing may readily produce alterations to, variations of, and equivalents to such embodiments. Accordingly, it should be understood that the present disclosure has been presented for purposes of example rather than limitation, and does not preclude inclusion of such modifications, variations and/or additions to the present subject matter as would be readily apparent to one of ordinary skill in the art.

What is claimed is:

1. A method comprising:
receiving a video signal associated with an experience;
applying an enhancement to the video signal to create an enhanced video; and
transmit a signal associated with the enhanced video, wherein the enhancement comprises an addition provided by a sharer of the experience to convey an emotion of the sharer about the experience.

2. The method of claim 1, further comprising displaying a set of enhancements in a user interface.

3. The method of claim 1, further comprising monitoring an audio signal associated with the video signal for one or more words.

4. The method of claim 3, further comprising applying an enhancement to the video signal upon detection of a predetermined word.

5. The method of claim 1, wherein the enhancement comprises one or more of visual cues or audio cues added to the video signal.

6. The method of claim 5, wherein the visual cues comprise one or more of: a distortion to objects or people in an image, an additional color or contrast, or a text box.

7. The method of claim 1, wherein the video signal comprises a pre-recorded video.

8. The method of claim 1, wherein the video signal comprises a video signal received from a camera of a smartphone.

9. The method of claim 8, wherein the video signal comprises a video associated with augmented reality.

10. The method of claim 1, wherein the enhanced video is displayed to a recipient via a virtual reality headset.

11. A system comprising:
a processor configured to:
receive a video signal associated with an experience;
apply an enhancement to the video signal to create an enhanced video; and
transmit a signal associated with the enhanced video, wherein the enhancement comprises an addition provided by a sharer of the experience to convey an emotion of the sharer about the experience.

12. The system of claim 11, wherein the processor is further configured to display a set of enhancements in a user interface.

13. The system of claim 11, wherein the processor is further configured to monitor an audio signal associated with the video signal for one or more words.

14. The system of claim 13, wherein the processor is further configured to apply an enhancement to the video signal upon detection of a predetermined word.

15. The system of claim 11, wherein the enhancement comprises one or more of visual cues or audio cues added to the video signal.

16. The system of claim 15, wherein the visual cues comprise one or more of: a distortion to objects or people in an image, an additional color or contrast, or a text box.

17. The system of claim 11, wherein the video signal comprises a pre-recorded video.

18. The system of claim 11, wherein the video signal comprises a video signal received from a camera of a smartphone.

19. The system of claim 18, wherein the video signal comprises a video associated with augmented reality.

20. A non-transitory computer readable medium comprising instructions that when executed by one or more processors cause the one or more processors to:
receive a video signal associated with an experience;
apply an enhancement to the video signal to create an enhanced video; and
transmit a signal associated with the enhanced video, wherein the enhancement comprises an addition provided by a sharer of the experience to convey an emotion of the sharer about the experience.
